(19) United States
(12) Patent Application Publication
(10) Pub. No.: US 2012/0241475 A1
(43) Pub. Date: Sep. 27, 2012

(54) Multi-Chamber Trigger Sprayer

(76) Inventor: Stephen R. Dennis, Danville, CA (US)

(21) Appl. No.: 13/070,622

(22) Filed: Mar. 24, 2011

(51) Int. Cl. B05B 7/04; B67D 7/78; B05B 11/00

(52) U.S. Cl. 222/137; 222/145.1; 222/464.1; 222/321.8

(57) ABSTRACT

Described is a multi-chamber trigger sprayer, and fluid dispensing apparatuses, including a sprayer housing including a pump piston and at least two pump chambers, a closure attachment configured to couple the trigger sprayer to an opening of a container, at least two fluid discharge passageways, each passageway in fluid communication with one of the pump chambers, wherein axes of each of the at least two pump chambers and at least portions of each of the at least two fluid discharge passageways are configured to be parallel to the axis of the opening of the container, and a biasing element configured to bias the pump piston. Axes of the first and second pump chambers, at least portions of the first and second fluid discharge passageways, and the biasing element, may be configured to be parallel to the axis of the opening of the multi-chamber fluid dispensing container. Other embodiments may also be disclosed and claimed.

### BACKGROUND

1. Field of the Invention

Embodiments of the present disclosure relate to multi-chamber trigger sprayers configured to combine and discharge two or more fluids, and to apparatuses including a multi-chamber trigger sprayer.

2. Description of the Related Art

Trigger sprayers are those types of sprayers that can be held in a single hand of the user and operated by the fingers of the user's hand to pump fluid from a container connected to the trigger sprayer. A trigger sprayer typically includes a sprayer housing that contains a pump chamber and piston, and a sprayer fluid supply passageway that fluidly communicates a fluid inlet opening (sometimes also referred to as a “connector aperture”) with the pump chamber.

A dip tube is often sealingly coupled to the connector aperture, and extends through a neck of a container and into fluid contents of the container. The dip tube fluidly communicates the container with the fluid supply passageway of the sprayer housing.

Although the conventional trigger sprayer and container may be suitable for various applications, there may be situations in which it is undesirable to package a fluid product in a container due to instability or hazardousness of the fluid product. In these situations, mixing at the point of use of precursor fluids may be a suitable alternative.

### SUMMARY OF THE INVENTION

The present disclosure provides a multi-chamber trigger sprayer. The trigger sprayer may be configured to couple to a container, and may include at least two fluid discharge passageways. The trigger sprayer may include a pump piston and at least two pump chambers, and a closure attachment configured to couple the trigger sprayer to an opening of a container. Each fluid discharge passageway may be in fluid communication with one of the pump chambers. The trigger sprayer may include a biasing element that may be configured to bias the pump piston, wherein axes of each of the at least two pump chambers, at least portions of each of the at least two fluid discharge passageways, and the biasing element, are configured to be parallel to the axis of the opening of the container.

The trigger sprayer may include a trigger mounted on a sprayer housing for pivoting movement, the trigger being configured to actuate the pump piston to cause one or more fluids to be drawn from the container to corresponding ones of the pump chambers, and dispense the fluids from corresponding ones of the pump chambers to corresponding ones of the fluid discharge passageways.

The trigger sprayer may include a nozzle assembly configured to combine the fluids from the fluid discharge passageways, and discharge the combined fluid from the trigger sprayer upon actuation of the pump piston.

The present disclosure also provides a fluid dispensing apparatus comprising a multi-chamber fluid dispensing container and a multi-chamber trigger sprayer coupled to the multi-chamber fluid dispensing container. The container may include a body having at least one wall defining a first interior cavity and a second interior cavity, and a neck coupled to the body and including an opening providing access to the first interior cavity and to the second interior cavity. The multi-chamber trigger sprayer may include a first fluid discharge passageway fluidly connected to the first interior cavity, and a second fluid discharge passageway fluidly connected to the second interior cavity.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows a partially-sectioned side elevation view of a multi-chamber trigger sprayer, in accordance with a first embodiment of the present disclosure;

FIG. 2A shows a partially-sectioned plan view of the multi-chamber trigger sprayer of FIG. 1 taken along line 2A-2A;

FIG. 2B shows a partially-sectioned plan view of the multi-chamber trigger sprayer of FIG. 1 taken along line 2B-2B;

FIG. 3 shows a partially-sectioned side elevation view of the multi-chamber trigger sprayer of FIG. 1, with the trigger partially depressed;

FIG. 4 shows a partially-sectioned side elevation view of a multi-chamber trigger sprayer, in accordance with a second embodiment of the present disclosure;

FIG. 5 shows a side elevation view of an apparatus including the multi-chamber trigger sprayer of FIG. 1 and a multi-chamber fluid dispensing container, in accordance with various embodiments of the present disclosure;

FIG. 6 shows a perspective view of an apparatus including a multi-chamber trigger sprayer and a multi-chamber fluid dispensing container, with the trigger sprayer removed from the fluid dispensing container, both in accordance with a third embodiment of the present disclosure; and

FIG. 7 shows a perspective view of an apparatus including a multi-chamber trigger sprayer and a multi-chamber fluid dispensing container, with the trigger sprayer removed from the fluid dispensing container, both in accordance with a fourth embodiment of the present disclosure

### DETAILED DESCRIPTION OF EMBODIMENTS

Reference will now be made to the drawings wherein like numerals refer to like parts throughout. For ease of description, the components of embodiments of the present invention are described in the normal (upright) operating position, and terms such as upper, lower, horizontal, etc., are used with reference to this position. It will be understood, however, that the components of embodiments of the present invention may be manufactured, stored, transported, used, and sold in an orientation other than the position described.

Figures illustrating the components of embodiments of the present invention show some conventional mechanical elements that may be known and that may be recognized by one skilled in the art. The detailed descriptions of such elements that are not necessary to an understanding of the invention, and accordingly are herein presented only to the degree necessary to facilitate an understanding of the novel features of the present invention.

As used herein and in the appended claims, the term “comprising” is inclusive or open-ended and does not exclude additional unrecited elements, compositional components, or method steps. Accordingly, the term “comprising” encompasses the more restrictive terms “consisting essentially of and “consisting of.”

It must be noted that, as used in this specification and the appended claims, the singular forms “a,” “an,” and “the” include plural references unless the content clearly dictates otherwise. Similarly, the use of substantially any plural terms herein may be translated by those having skill in the art from the plural to the singular as is appropriate to the context and/or application. The various singular/plural permutations may be expressly set forth herein for sake of clarity.

In those instances where a convention analogous to “at least one of A, B, and C, etc.” is used, in general such a construction is intended in the sense one having skill in the art would understand the convention (e.g., “an apparatus having at least one of A, B, and C” would include but not be limited to apparatuses that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 elements refers to groups having 1, 2, or 3 elements. Similarly, a group having 1-5 elements refers to groups having 1, 2, 3, 4, or 5 elements, and so forth.

Unless defined otherwise, all technical and scientific terms used herein have the same meaning as commonly understood by one of ordinary skill in the art to which embodiments of the present invention pertain. Although a number of methods and materials similar or equivalent to those described herein can be used in the practice of the present invention, the preferred materials and methods are described herein.

The term “container” or “bottle,” as used herein, is meant to mean and include any container for holding a fluid material. A container or bottle may be made of any suitable material, depending upon the product therein. For example, a container or bottle may be made of plastic.

Broadly, embodiments of the present invention provide multi-chamber trigger sprayers configured to combine and discharge two or more fluids, and to apparatuses including a multi-chamber trigger sprayer. The multi-chamber trigger sprayer may include a sprayer housing including a pump piston and at least two pump chambers, a closure attachment configured to couple the trigger sprayer to an opening of a container, and at least two fluid discharge passageways, each passageway in fluid communication with one of the pump chambers. A biasing element may be configured to bias a pump piston of the multi-chamber trigger sprayer, wherein axes of each of the at least two pump chambers, at least portions of each of the at least two fluid discharge passageways, and the biasing element, are configured to be parallel to the axis of the opening of the container.

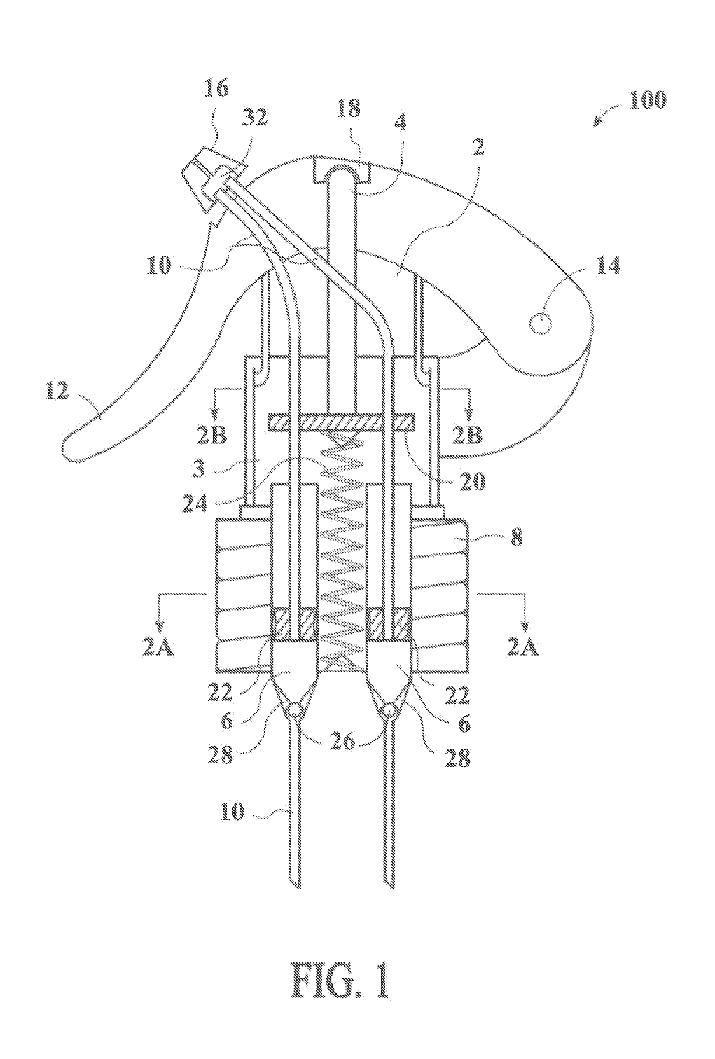

FIG. 1 is a partially-sectioned side elevation view of a multi-chamber trigger sprayer 100, in accordance with various embodiments of the present disclosure. The trigger sprayer 100 may include a sprayer housing 2 including a pump piston 4, at least two pump chambers 6, and a closure attachment 8 configured to couple the trigger sprayer 100 to an opening of a container. The trigger sprayer 100 may also include at least two fluid discharge passageways 10. Each passageway 10 may be in fluid communication with one of the pump chambers 6 as shown, wherein axes of each of the at least two pump chambers 6 and at least portions of each of the at least two fluid discharge passageways 10 are configured to be parallel to the axis of the opening of the container, as shown more clearly herein.

The trigger sprayer 100 may include a trigger 12 mounted on the sprayer housing 2, 3 for pivoting movement about a pivot point 14, and a nozzle assembly 16 for dispensing a fluid from the trigger sprayer 100. The sprayer housing 2, 3 may be configured in any manner suitable for practicing the described embodiments. For example, the sprayer housing 2, 3 may have a telescoping configuration as shown in which a first portion 2 moves along with the trigger 12, upon depression and release, sliding into (or outside of, not shown) the fixed second portion 3 of the housing.

The trigger 12 may be configured to actuate the pump piston 4 to cause fluids to be drawn from a container, to which the trigger 12 may be attached, to the at least two pump chambers 6 and then dispensed from the at least two pump chambers 6 to the at least two fluid discharge passageways 10. As shown, the pump piston 4 includes a first piston element 20 skirting each of the fluid discharge passageways 10, and second piston elements 22 located in each of the pump chambers 6. The first piston element 20 may skirt or otherwise be coupled to each of the fluid discharge passageways 10, may also be in contact with a biasing element 24 as illustrated. One or more of the fluid discharge passageways 10 may comprise a flexible tubing material or any other tubing suitable for practicing the described embodiments.

Rather than being located within the pump chambers 6, in various embodiments, the biasing element 24 may be located externally to the pump chambers 6, as shown. In this configuration, fewer parts may be required for assembling the trigger sprayer 2. The biasing element 24 may be a metal or plastic spring, or any other suitable apparatus or material for biasing upward toward the first piston element 20.

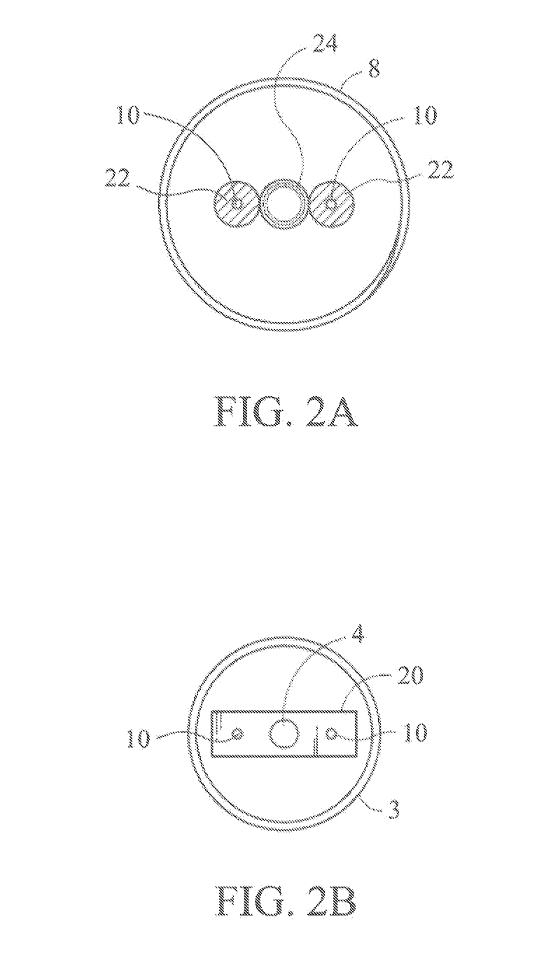

To facilitate understanding of the structure of the trigger sprayer 100, various plan views are shown in FIG. 2A-2C. FIG. 2A is a partially-sectioned plan view of the trigger sprayer 100 taken generally along line 2A-2A of FIG. 1, showing the closure attachment 8, the biasing element 24, the fluid discharge passageways 10, and the second piston elements 22. FIG. 2B is a partially-sectioned plan view of the trigger sprayer 100 taken generally along line 2B-2B of FIG. 1, showing the piston 4 including the first piston element 20, the fluid discharge passageways 10, and the sprayer housing 3.

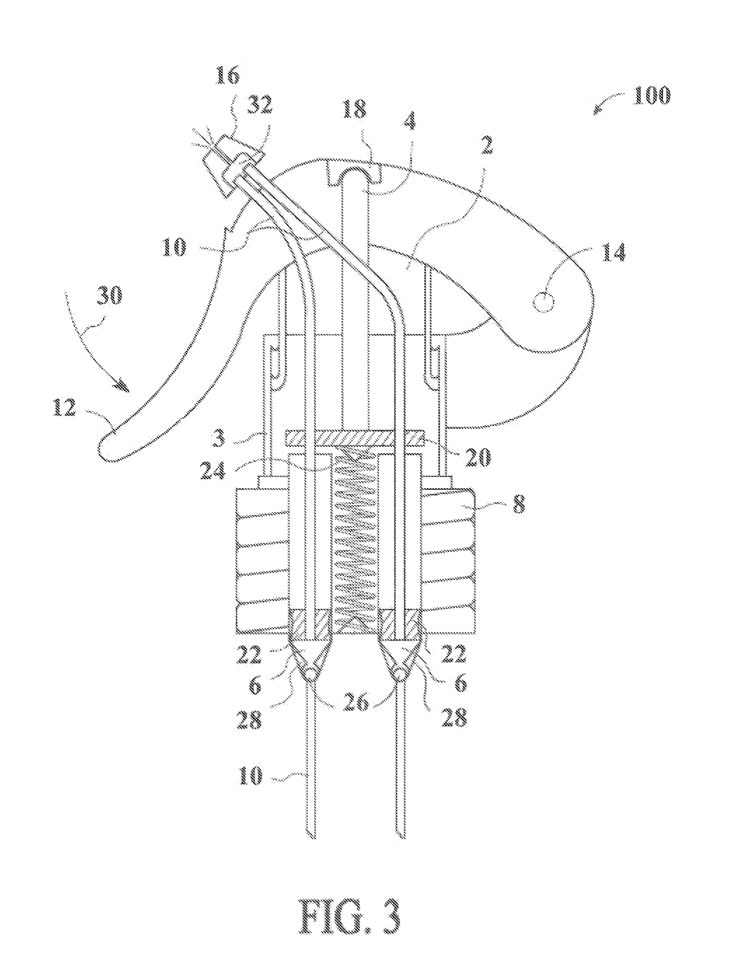

Operation of the trigger sprayer 100 may be understood with reference to FIG. 3 with continued reference to FIG. 1. A shown, the sprayer housing 2 may include a notch 18 or similar feature for pressing down against the pump piston 4 with appurtenant compression of the pump chambers 6 by the pump elements 22 during operation of the trigger sprayer 100 (i.e., when the trigger 12 is depressed). When the trigger is depressed along direction 30, the pump piston sections 22 are forced downwards, compressing the bottom portions of the pump chambers 6, as illustrated in FIG. 3.

Attached to the pump chambers 6 are one-way valves, each including a valve ball 26 and a keeper 28 for limiting up and down movement of the valve balls 26. As with typical one-way valves, fluid flow is limited to one direction, and prevented in the opposite direction. Accordingly, in operation of the trigger sprayer 100, on the downstroke, the valve balls 26 block flow of fluid back down into the bottom portion of the fluid passageways 10, thereby causing increased pressure within the pump chambers 6. The increased pressure causes fluid to flow from the pump chambers 6 up through the fluid discharge passageways 10, and to the nozzle assembly 16 for discharge from the trigger sprayer 100.

Prior to discharge from the nozzle assembly 16, the fluids from each of the fluid discharge passageways 10 may be combined in a mixing chamber 32. Accordingly, the configuration of the trigger sprayer 100 may allow for separate types of fluids to be mixed just at the point-of-use. For example, it may be undesirable in some situations to package a fluid product in a container due to instability or hazardousness of the fluid product. In these or other situations, mixing at the point of use of precursor fluids may be a suitable alternative.

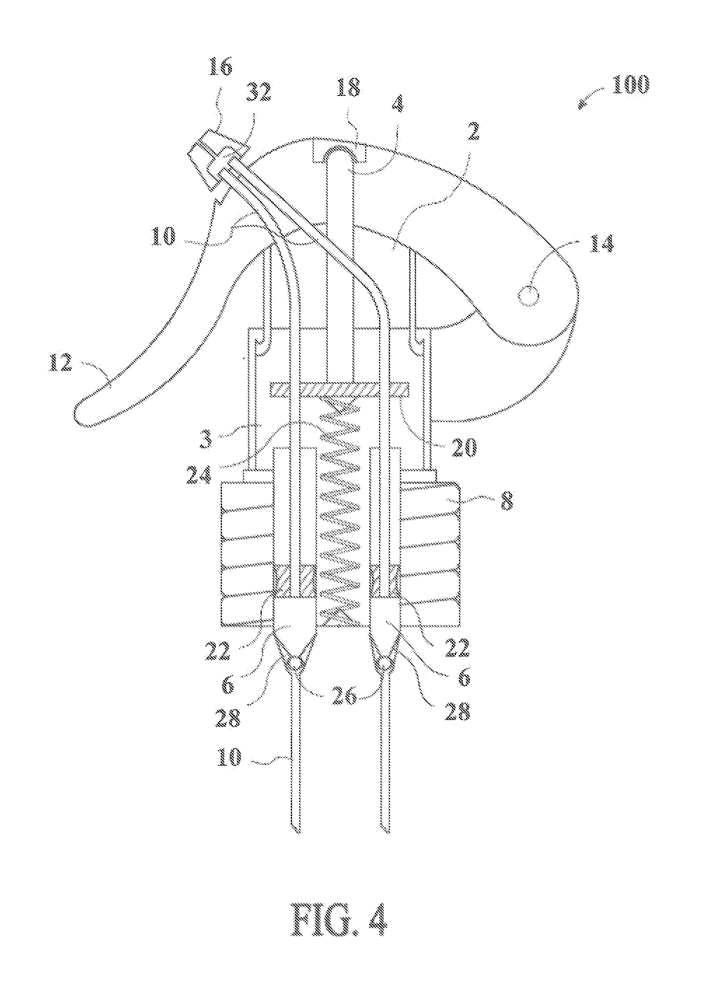

The ratio of precursor fluids combined at the mixing chamber 32 of the nozzle assembly 16 may be one-to-one or other than one-to-one. In various embodiments for other than one-to-one mixing, the trigger sprayer 100 may be configured to combine a first volume of a first precursor fluid from a first interior cavity of a container with a second volume of a second precursor fluid from a second interior cavity of the container, wherein the first volume is different from the second volume. FIG. 4 shows a partially-sectioned side elevation view of a multi-chamber trigger sprayer, in accordance with a second embodiment of the present disclosure, in which the piston chambers 6 are two different sizes, and accordingly, configured to hold two different volumes of fluid. Thus, when the trigger 12 is depressed, the pump piston sections 22 are forced downwards, compressing the bottom portions of the pump chambers 6, forcing two different volumes of fluid from the pump chambers 6 up through the fluid discharge passageways 10. The differing volumes of fluids may then be combined in the mixing chamber 32, and then discharged by the nozzle assembly 16.

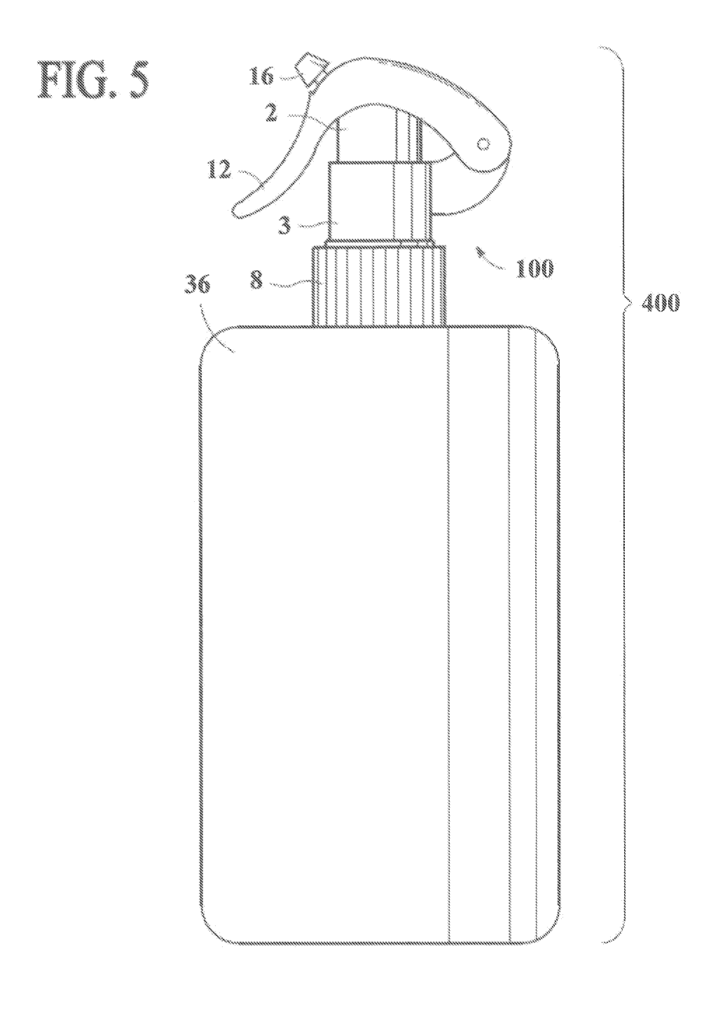

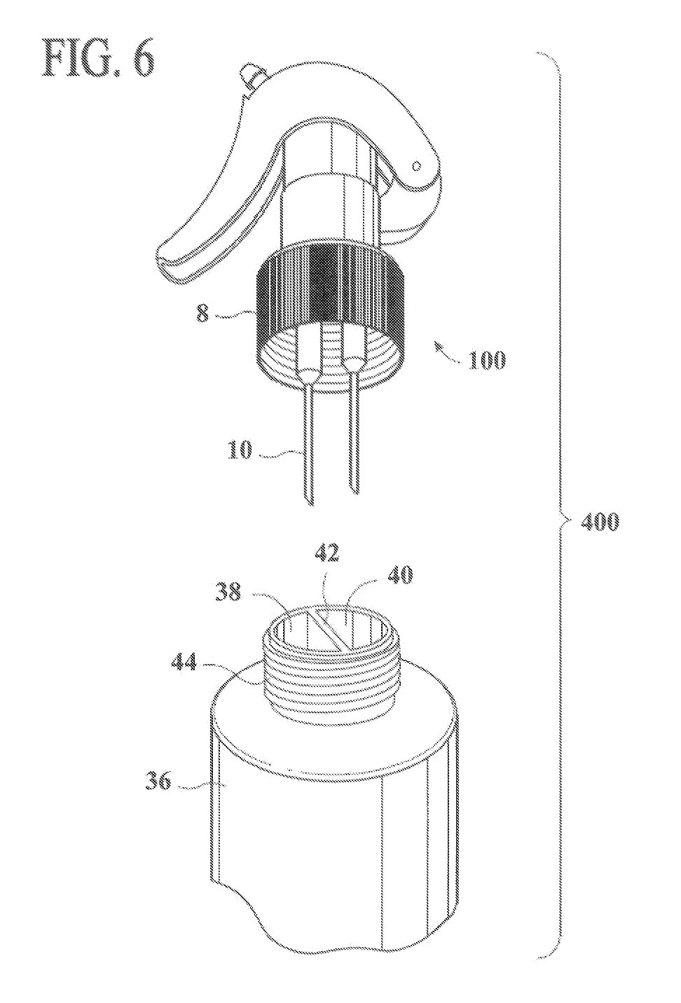

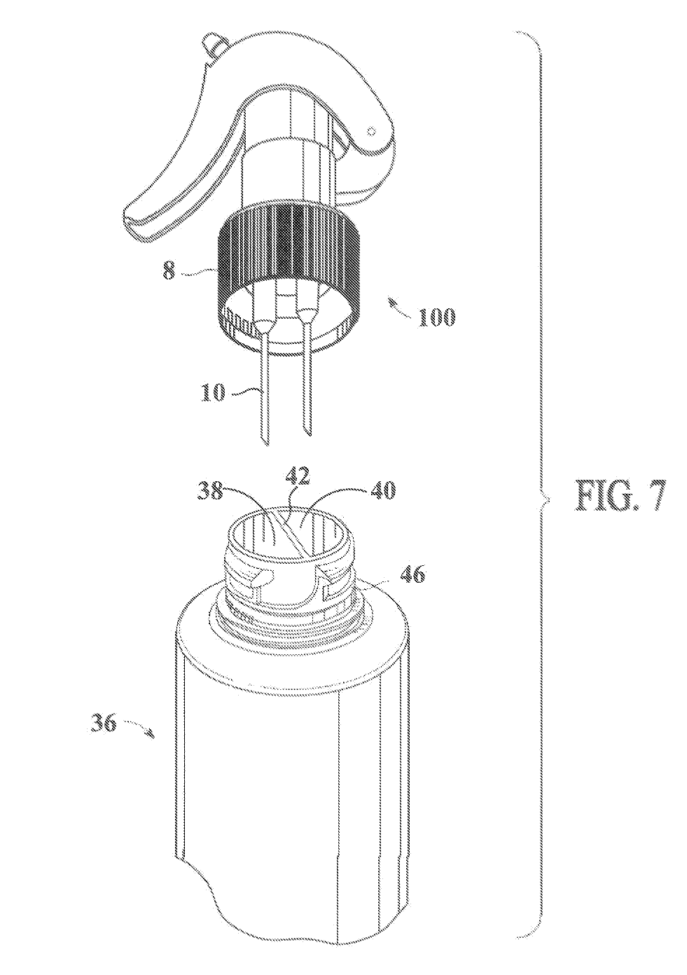

FIG. 5 shows an example fluid dispensing apparatus 400 including a multi-chamber trigger sprayer 100 and a multi-chamber fluid dispensing container 36, both in accordance with various embodiments of the present disclosure. FIG. 6 shows a perspective view of the fluid dispensing apparatus 400. The closure attachment 8 of the trigger sprayer 100 may be coupled to the container 36 as shown. To facilitate attachment, the closure attachment 8 may be configured to correspond to the fitment 44 of the trigger sprayer 100. As illustrated, the container 36 may include a threaded fitment 44, and the trigger sprayer 100 may be complementary configured with a threaded closure attachment 8. Alternatively, the container 36 may include a bayonet-type fitment 46, and the trigger sprayer 100 may be complementary configured with a bayonet-type closure attachment 8, as shown in FIG. 7.

As shown in FIG. 6 and FIG. 7, the container 36 may include a first interior cavity 38 and a second interior cavity 40, corresponding to first and second fluid discharge passageways described herein. The first interior cavity 38 and the second interior cavity 40 may be separated from each other by a divider wall 42 to ensure no mixing of fluids between the cavities 38, 40 prior to discharge from the trigger sprayer 100. When the trigger sprayer 100 and container 36 are coupled, the fluid discharge passageways 10 may be fluidly connected to respective interior cavities 38, 40.

As described herein, prior to discharge from the nozzle assembly 16, the fluids from each of the fluid discharge passageways 10 may be combined in a mixing chamber 32 of the nozzle assembly 16 to allow fluids to be mixed at the point-of-use. The separate interior cavities 38, 40 may thus hold the separate precursor fluids for combining at the mixing chamber 32.

For embodiments in which the ratio of precursor fluids combined at the mixing chamber 32 of the nozzle assembly 16 is one-to-one, the cavities 38, 40 of the container 36 may have substantially the same fluid capacities. For embodiments in which the ratio of precursor fluids combined at the mixing chamber 32 of the nozzle assembly 16 is other than one-to-one, however, it would be expected that more of one of the precursor fluids would be needed than the other one of the precursor fluids. Accordingly, the interior cavities 38, 40 may be configured with differing fluid capacities to allow one of the cavities 38, 40 to hold more than the other one of the cavities 38, 40.

Among the various benefits of the described embodiments, providing pump chamber chambers and at least portions of each of the fluid discharge passageways having axes parallel to the axis of the opening of the container may simplify the manufacturing process for making the trigger sprayer relative to various other related art trigger sprayers. For example, the piston 4 and pump chamber 6 may be produced in one part and coupled to the closure attachment 8. The fluid discharge passageways 10 may be of a flexible material to allow the vertical orientation to transfer to a substantially horizontal orientation and to a fixed location. Disposing the biasing element 24 externally of the pump chambers 6 allows for a single biasing element to bias the multiple pump piston elements 20, 22, thereby reducing the number of parts required to manufacture the trigger sprayer. Disposing the biasing element 24 externally of the pump chambers 6 may also reduce exposure of the biasing element 24 to the fluids, possible extending the lifetime of the trigger sprayer.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the appended claims.

What is claimed is:

1. A trigger sprayer comprising:
a sprayer housing including a pump piston and at least two pump chambers;
a closure attachment configured to couple the trigger sprayer to an opening of a container; and
at least two fluid discharge passageways, each passageway in fluid communication with one of the pump chambers;
wherein axes of each of the at least two pump chambers and the at least portions of each of the at least two fluid discharge passageways, are configured to be parallel to an axis of the opening of the container.

2. The trigger of claim 1, further comprising a trigger mounted on the sprayer housing for pivoting movement, the trigger being configured to actuate the pump piston to cause fluids to be drawn from separate chambers of the container to the at least two pump chambers, and dispense the fluid from the at least two pump chambers to the at least two fluid discharge passageways.

3. The trigger of claim 1, further comprising a nozzle assembly configured to combine fluids from the at least two fluid discharge passageways, and discharge the combined fluid from the trigger sprayer upon actuation of the pump piston.

4. The trigger of claim 1, further comprising a biasing element configured to bias the pump piston to an upward position, wherein an axis of the biasing element is configured to be parallel to the axis of the opening of the container.

5. The trigger of claim 1, wherein the at least two pump chambers comprises a first pump chamber and a second pump chamber, and wherein the at least two fluid discharge passageways comprises a first discharge passageway and a second discharge passageway.

6. The trigger of claim 5, wherein the first pump chamber has a first fluid volume, wherein the second pump chamber has a second fluid volume, and wherein the first fluid volume and the second fluid volume are substantially the same.

7. The trigger of claim 5, wherein the first pump chamber has a first fluid volume, wherein the second pump chamber has a second fluid volume, and wherein the first fluid volume and the second fluid volume are different.

8. The trigger of claim 1, wherein the biasing element is disposed externally of the at least two pump chambers.

9. The trigger of claim 1, wherein at least one of the at least two fluid discharge passageways comprises a flexible tube.

10. The trigger of claim 1, wherein the closure attachment comprises a threaded attachment or a bayonet-type attachment.

11. A fluid dispensing apparatus comprising:
a multi-chamber fluid dispensing container including:
a body having at least one wall defining a first interior cavity and a second interior cavity;
a neck coupled to the body and including an opening providing access to the first interior cavity and to the second interior cavity;
a multi-chamber trigger sprayer coupled to the neck of the multi-chamber fluid dispensing container, and including:
a first fluid discharge passageway fluidly connected to the first interior cavity, and a second fluid discharge passageway fluidly connected to the second interior cavity;
a first pump chamber connected to the first fluid discharge passageway, and a second pump chamber connected to the second fluid discharge passageway; and
a biasing element configured to bias a pump piston of the multi-chamber trigger sprayer to an upward position;
wherein an axis of the biasing element is configured to be parallel to an axis of the opening of the container.

12. The fluid dispensing apparatus of claim 11, further comprising a trigger mounted on the sprayer housing.

13. The fluid dispensing apparatus of claim 12, wherein the trigger is mounted on the sprayer housing for pivoting movement, the trigger being configured to actuate the pump piston to cause fluids to be drawn from the first and second interior cavities of the multi-chamber fluid dispensing container to the first and second fluid discharge passageways.

14. The fluid dispensing apparatus of claim 12, further comprising a nozzle assembly configured to combine fluids from the first and second fluid discharge passageways, and discharge the combined fluid from the trigger sprayer upon actuation of the pump piston.

15. The fluid dispensing apparatus of claim 11, wherein the multi-chamber trigger sprayer further includes a closure attachment configured to couple the multi-chamber trigger sprayer to the neck of the multi-chamber fluid dispensing container.

16. The fluid dispensing apparatus of claim 15, wherein the multi-chamber fluid dispensing container further comprises a fitment coupling the neck of the multi-chamber fluid dispensing container with the multi-chamber trigger sprayer.

17. The fluid dispensing apparatus of claim 16, wherein the fitment comprises a threaded fitment or a bayonet-type fitment.

18. The fluid dispensing apparatus of claim 11, wherein the multi-chamber trigger sprayer is configured to combine a first volume of fluid from the first interior volume with a second volume of the fluid from the second interior volume, wherein the first volume is different from the second volume.

19. The fluid dispensing apparatus of claim 11, wherein the multi-chamber trigger sprayer is configured to combine a first volume of fluid from the first interior volume with a second volume of the fluid from the second interior volume, wherein the first volume is substantially the same as the second volume.

20. A fluid dispensing apparatus comprising:
a sprayer housing including a pump piston, a first pump chamber, and a second pump chamber;
a closure attachment configured to couple the sprayer housing to an opening of a multi-chamber fluid dispensing container; and
a first fluid discharge passageway and a second fluid discharge passageway, each fluid discharge passageway in fluid communication with one of the pump chambers;
a trigger mounted on the sprayer housing for pivoting movement to cause one or more fluids to be drawn from the container to corresponding ones of the first and second pump chambers and dispense the fluids from corresponding ones of the first and second pump chambers to corresponding ones of the first and second fluid discharge passageways;
a biasing element configured to bias the pump piston to an upward position, wherein the biasing element is disposed externally of the at least two pump chambers, wherein axes of the first and second pump chambers, at least portions of the first and second fluid discharge passageways, and the biasing element, are configured to be parallel to the axis of the opening of the multi-chamber fluid dispensing container; and
a nozzle assembly configured to combine the fluids from the first and second fluid discharge passageways and discharge the combined fluid from the trigger sprayer upon actuation of the pump piston.
